(19) United States
(12) Patent Application Publication
(10) Pub. No.: US 2021/0199181 A1
(43) Pub. Date: Jul. 1, 2021

(54) Double-Drive Backpack Power Unit

(71) Applicant: Iskco LTD., North Little Rock, AR (US)

(72) Inventor: Kenny D. Breeding, Maumelle, AR (US)

(73) Assignee: Iskco. LTD., North Little Rock, AR (US)

(21) Appl. No.: 17/136,877

(22) Filed: Dec. 29, 2020

Related U.S. Application Data
(60) Provisional application No. 62/955,000, filed on Dec. 30, 2019.

(51) Int. Cl. F16H 7/02; E04G 21/06; E01C 19/38

(52) U.S. Cl. CPC F16H 7/02; E01C 19/402; E01C 19/38; E04G 21/066

(57) ABSTRACT

A portable backpack-borne power unit used for concrete vibration and consolidation, that is switchable between left-handed and right-handed applications. The power unit can transmit motor-generated power to a variety of tools with various power cables known in the art. For concrete vibration, power is transmitted to a vibrator that is immersed within green concrete. The instant design enables the power connection at the power unit to be secured on either side of the backpack, effectively facilitating either left-handed or right-handed operation.

### CROSS REFERENCE TO RELATED APPLICATION

This utility conversion patent application is based upon, and claims priority from, a pending provisional patent application, Ser. No. 62/955,000, filed Dec. 30, 2019, entitled “Double-Drive Backpack Power Unit,” by inventor Kenny D. Breeding.

### BACKGROUND OF THE INVENTION

### 1. Field of the Invention

The present invention relates generally to portable, backpack power units including industrial vibrators for concrete consolidating. More particularly, the present invention relates to backpack-borne industrial vibrators comprising a double sided power output connection.

### 2. Description of the Prior Art

It is well known in the concrete finishing arts that freshly poured “green” concrete must be properly vibrated after placement to facilitate consolidation, i.e, proper hardening. Properly applied vibration settles and densifies the concrete mass, and minimizes air voids. Many known vibrating systems for consolidating concrete are presently in use. Preexisting concrete vibrating equipment ranges from extremely large, vibrating screed units that ride forms to traverse freshly poured concrete, to small portable units that may be transported with a backpack arrangement.

Portable vibration units secured to a backpack are known. These enable the contractor to properly densify smaller pours in a cost efficient manner. Backpack vibrator units enable the operator to easily reach difficult-to-access places that would otherwise be unreachable by large form-riding, vibrating systems.

Many prior art backpack designs employ a rigid frame with a pair of captivating shoulder straps. The user places his arms in the straps to lift and carry both the backpack and the load. Some backpack designs include waist belts mounted to the frame for distributing weight relatively evenly. A backpack with a waist belt eases the burden in carrying heavier loads presented by internal combustion engines. A number of small internal combustion engines borne by backpack systems power a diverse variety of tools, including weed trimmers, air blowers, vacuums, etc. As backpack mounting systems evolve, the engines continue to get more powerful, and consequently bigger and heavier. Also, the tools typically employed have become more diverse. Of course complex designs increase the cost of such units.

Known backpack-borne vibrator systems may employ a two-cycle engine that must run at relatively high RPM. The engine connects via a flex-shaft cable to an eccentric vibrator unit that is immersed within the concrete. The flex shaft is connected at the other end to the power unit, either on a left-mounted drive unit coupling or a right handed coupling. As the engine rotates a flex-shaft through the cable, vibration is created by the eccentric vibrator, and transmitted to the concrete. Thus known backpack vibrator units are either “left handed” or “right handed” which limits the effectiveness of a given unit as it cannot be comfortably used by both left-handed and right-handed people.

U.S. Pat. No. D436,732 issued to me Jan. 30, 2001 and entitled “swivel assembly for back-pack mounted equipment” discloses the ornamental appearance of a prior art back pack arrangement with a swivel.

U.S. Pat. No. 5,716,131 issued to me Feb. 10, 1998 and entitled “Portable four cycle backpack pendulous vibrator” discloses a backpack for a portable concrete vibrator with a four cycle engine that powers a pendulous vibrator. The backpack comprises a rigid frame mounting the motor and a removable vibration absorption system isolates the user from stress. A pair of integral, divergent shoulder harnesses protrude from the backpack top and an encircling, semi-elastic waist belt protrudes from the bottom. An integral belt tensioner on each side of the belt permits the user to tighten one or both belt sides to adjust belt tightness. The backpack vibration dampening system is removable for cleaning or adjustment. The dampening system preferably comprises a thick pad that has a pair of slip-on cuffs to captivate the ends of both shoulder harnesses. A plurality of snaps or other conventional attachment points secure the remainder of the system to the frame. The frame also mounts a pair of ergonomic controls that may be easily manipulated by the user to control the power unit. The elongated flex-cable that connects the vibrator to the four cycle engine includes an internal compensator that accommodates vibrational stresses and thermal expansion and contraction.

U.S. Pat. No. 5,829,874 issued to me Nov. 3, 1998 and entitled “Backpack mounted pivoting motor for concrete finishing” discloses a portable backpack-borne, vibrator system. The backpack portion includes a removable vibration absorption system that isolates the user from stress, which comprises a pair of integral, divergent shoulder harnesses and an encircling, semi-elastic waist belt near the bottom. An integral belt tensioner permits the user to adjust belt tightness. The dampening system comprises a removable pad that has a pair of slip-on cuffs to captivate the ends of both shoulder harnesses.

U.S. Pat. No. 6,065,859 issued to me May 23, 2000 and entitled “Portable pendulous concrete vibrator” discloses a portable, hand-held concrete vibrating system with a pendulous vibrator driven by a high speed motor.

An ideal concrete vibrator backpack system should meet a number of requirements. The system must enable the user to safely and comfortably transport the load on his back, and the backpack should be comfortable to wear. Stability is important. The unit must distribute its load relatively evenly to preserve operator mobility and balance. Weight borne upon the shoulders of the wearer must be cushioned to avoid rashes and discomfort. Mechanical parts should be compactly mounted to avoid obstructing or contacting the operator. Of course, vibration and heat must be isolated from the wearer as much as practicable.

Not only must the unit meet the foregoing considerations, it is highly desirable for a modern backpack vibrator to be adaptable for use by both left-handed and right-handed workers.

### SUMMARY OF THE INVENTION

This invention provides a portable backpack-borne power unit that can ideally be used for concrete vibration and consolidation, that is switchable between left-handed and right-handed applications. The power unit can transmit motor-generated power to a variety of tools with various power cables known in the art. For concrete vibration, power is transmitted to a vibrator that is immersed within green concrete. Importantly, the instant design enables the power connection at the power unit to be secured on either side of the backpack, effectively facilitating either left-handed or right-handed operation.

Thus the most basic basic object is to provide a highly stable, portable backpack power unit.

More particularly it is an object to provide a portable power unit that can be switched between left-handed and right-handed deployments.

A related object is to provide a power unit of the character described that can used by either left-handed or right-handed workers.

Another important object is to minimize a contractor's expenses and increase the dexterity of portable backpack power units.

Another basic object is to consolidate or density green concrete.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a right side perspective view of a Double-Drive Backpack Power Unit constructed in accordance with the best mode of the invention.

FIG. 2 is a left side perspective view thereof;

FIG. 3 is an enlarged fragmentary, perspective view of the drive unit of a prior art “single sided” unit;

FIG. 4 is a rear plan view of the unit of FIGS. 1 and 2; FIG. 5 is an enlarged, fragmentary view of the double sided drive unit, taken generally from circled region “5” in FIG. 4;

FIG. 6 is a fragmentary perspective view taken generally along line 6-6 of FIG. 5;

FIG. 7 is a fragmentary perspective view taken generally along line 7-7 of FIG. 6;

FIG. 8 is an enlarged, fragmentary longitudinal sectional view of the double ended drive; and,

FIG. 9 is an exploded isometric view of the drive of FIG. 8.

### DETAILED DESCRIPTION

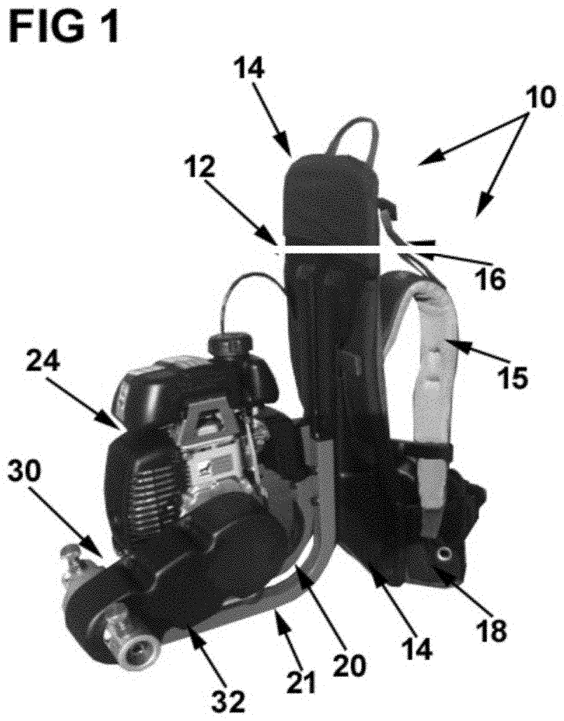

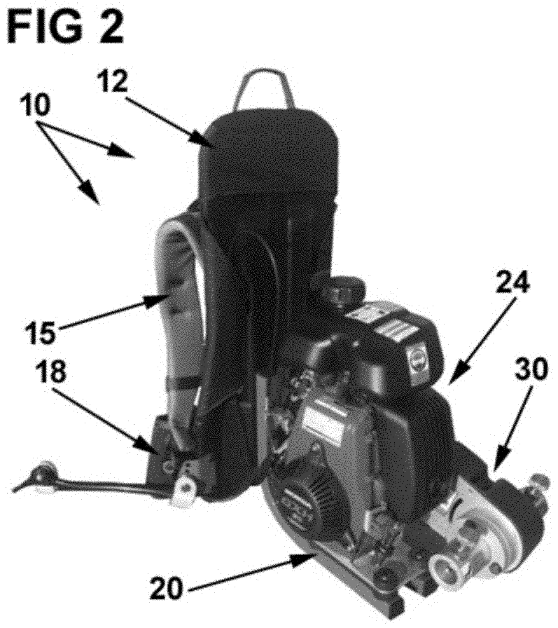

Initially referencing FIGS. 1 and 2 of the drawings, a “Double-Drive Backpack Power Unit” constructed in accordance with the best mode known at this time has been generally designated by the reference numeral 10. Basic details as to backpack type portable concrete vibrators are discussed in the Iskco LTD U.S. Pat. Nos. 5,829,874, and 5,716,131. cited earlier, that are hereby incorporated by reference for purposes of disclosure.

The backpack power unit 10 comprises a backpack 12 that has a resilient, generally rectangular back plate 14 from which conventional straps 15 project (FIG. 1). There are a pair of upper, arcuate shoulder braces 16 (FIG. 2) for transferring weight to the users shoulders and upper torso. The lower portion of back plate 14 may support an arcuate, torso engaging brace 18 that embraces the wearer's lower torso above the hips.

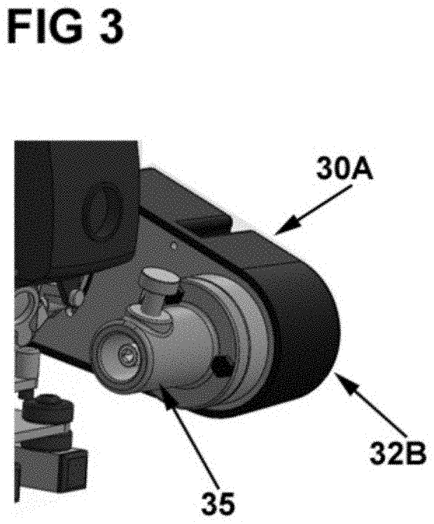

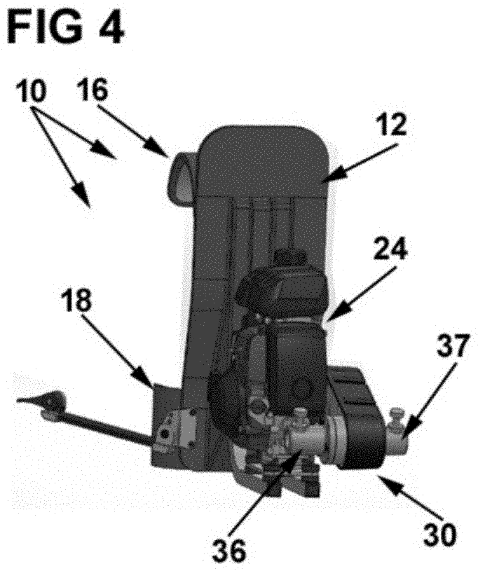

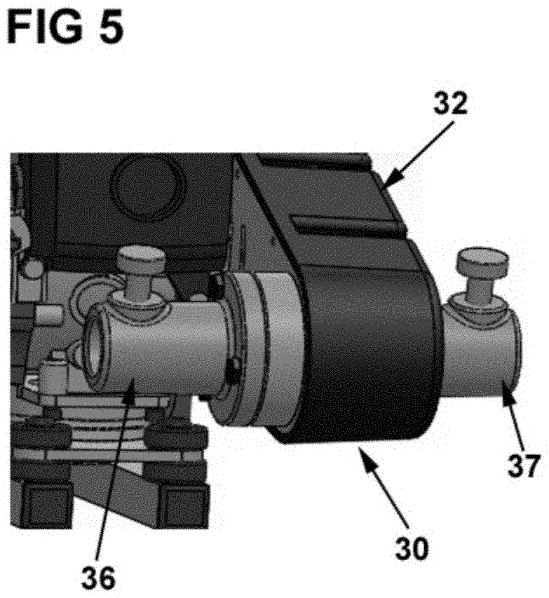

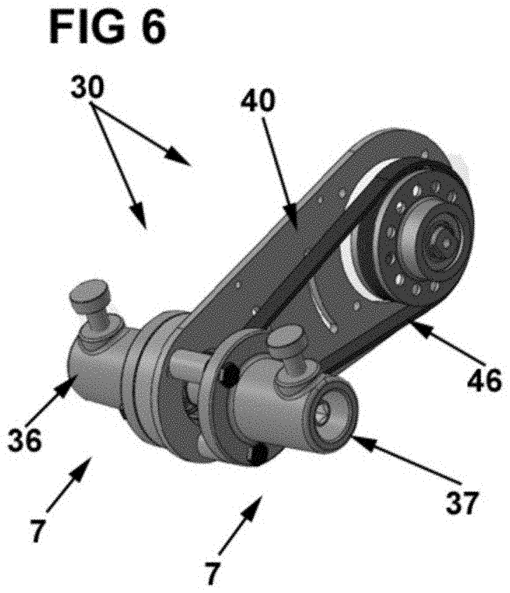

Importantly there are a pair or rigid, arcuate supports 20 and 21 extending rearwardly from the back plate 14 for mounting a standard internal-combustion engine 24 of the type described in the above-referenced Iskco patents, along with motor accessories and its important drive output. The preferably belt-driven power output system 30 is preferably shrouded within a protective, plastic enclosure 32. As seen in FIGS. 4-7 for example, the power output system 30 terminates in a pair of oppositely directed coupling bodies 36 and 37 that enable the power vibrator shaft to be coupled in either e left-handed or right-handed configuration. If FIG. 3 a portion of a prior art Iskco back pack vibrator shows only one coupling body 35, emanating from the older power output system 30A that includes shroud 32B.

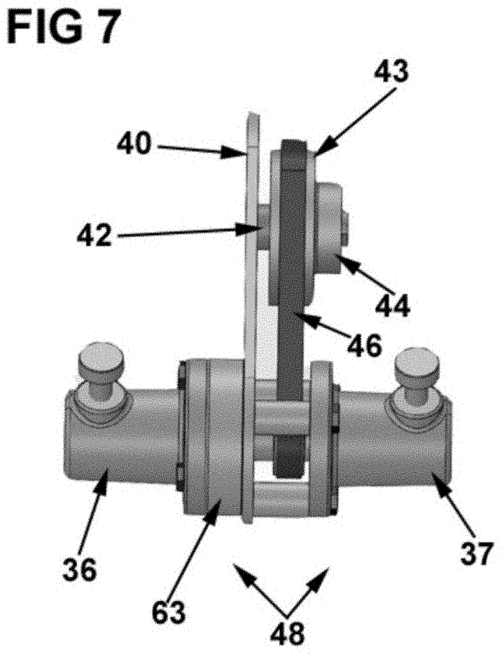

The belt-driven power output system 30 a rigid, supportive mounting plate 40 acting as a supportive frame that is somewhat shaped like an oval. Plate 40 supports an axle 42 splined to a drive pulley 43 that is locked with a collet 44. A drive belt 46 is entrained over a drive shaft 47, that forms part of the double drive transmission 48 (FIG. 7). Drive shaft 47 extends between both couplings 36, 37.

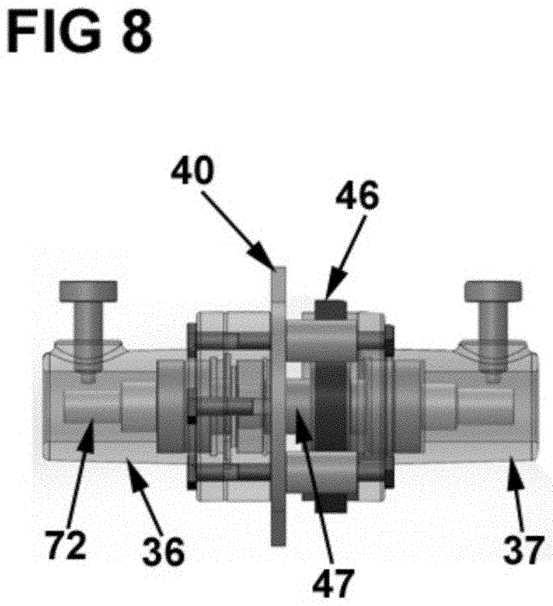

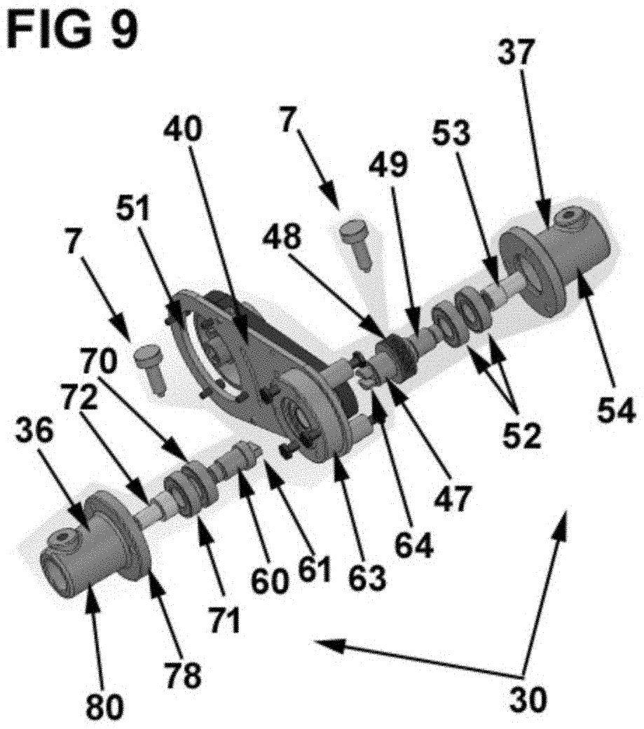

With concurrent reference now directed to FIGS. 7-9, the “double drive” transmission 48 comprises suitable “pass through” orifices 51 (FIG. 9) for component clearance. Shaft 47 has a belt-driven drive portion 48 integral with a terminal end 49 that passes through aligned concentric bearings 52 and longitudinally connects with a drive joint 53 extending into housing 54 of coupling 37. On the other side a shaft 60 with a longitudinal coupling end 61 passes through mounting flange 63 to longitudinally connect with opposite shaft end 64 for axial rotation. Shaft 60 (FIG. 9) passes through bearings 70, 71 and half shaft drive joint 72 that passes through flange 78 on housing 89.

The mounting plate 40 is machined for “pass through” double ended shaft (female end) which is machined with RH threads and the male end of shaft is machined with LH threads. This feature allows for the opposite rotation always tightening components during loading.

Drive joint 53 is machined with RH threads and 9mm square drive. The drive joint 72 is machined with LH threads and ¼″ square drive. Either drive joint can be machined to fit any brand vibrator shaft in the industry.

From a distributor standpoint #5 Mount Flange can be moved from side to side allowing a distributor to sell either right, left or double sided product by adding or removing a bolt on cover (not shown).

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. A backpack power unit for concrete vibrators:
a back plate;
straps secured to the back plate for securing the unit;
a pair of arcuate shoulder braces for transferring weight to a user;
supports extending rearwardly from the back plate for mounting a standard internal-combustion engine and its accessories; and,
power output system comprising a pair of oppositely directed coupling bodies that enable a power vibrator shaft to be coupled in either a left-handed or right-handed configuration.

2. The backpack unit as defined in claim 1 further comprising:
an axle splined to a drive pulley that is locked with a collet;
a drive shaft;
a drive belt entrained over the drive shaft; and, said drive shaft extending between both said coupling bodies.

3. The backpack unit as defined in claim 1 further comprising wherein a lower portion of said back plate supports an arcuate, torso engaging brace that embraces the wearer's lower torso above the hips.

4. The backpack unit as defined in claim 3 further comprising:
an axle splined to a drive pulley that is locked with a collet;
a drive shaft;
a drive belt entrained over the drive shaft; and,
said drive shaft extending between both said coupling bodies.
